(19) United States
(12) Patent Application Publication
(10) Pub. No.: US 2007/0283614 A1
(43) Pub. Date: Dec. 13, 2007

(54) MULTIPURPOSE CADDY

(76) Inventors: Kraig Kessler, Gardner, KS (US); Robert Laquet, Spring Hill, KS (US)

Correspondence Address: HOVEY WILLIAMS LLP, Suite 400, 2405 Grand Blvd., Kansas City, MO, 64108, US

(21) Appl. No.: 11/423,568

(22) Filed: Jun. 12, 2006

(51) Int. Cl. A01K 97/10; A01K 97/22

(52) U.S. Cl. 43/54.1; 43/21.2

(57) ABSTRACT

A multipurpose caddy (12) especially designed for boat seats (16) is provided which an elongated plate (42) located beneath seat (16) and of a length to present segments (50,52) each extending laterally beyond a side marginal surface (34) of the seat (16). The plate segments (50,52) are each equipped with utility holders (54-58), preferably in the form of beverage container holders (54,56) and a utility box (58). The caddy (12) also has a fishing rod holder (64) designed to hold the handle end of a fishing rod and oriented obliquely for convenient rod holding. The caddy (12) is secured between a seat support (14 ) and a seat (16), by means of mounting screws (26) extending through the support (14), plate (42) and received within the seat (16).

### BACKGROUND OF THE INVENTION

1. Field of the Invention

The present invention is broadly concerned with utility caddies especially designed for attachment to boat seats in order to assist a fisherman sitting upon the seat. More particularly, the invention is concerned with such caddies, and overall seat and caddy combinations, wherein the caddies preferably include an obliquely mounted fishing rod holder, as well as utility holders (e.g., beverage container and fishing tackle holders) mounted on laterally extending caddy projections.

2. Description of the Prior Art

Fishing boats are commonly provided with a series of seats spaced about the upper deck thereof for the convenience of fishermen. These seats allow a fisherman to comfortably sit while holding a fishing rod. However, during the course of an extended fishing trip, the fishermen will inevitably want to move about the boat and consume beverages from typical containers such as cups or cans. This presents several problems, including the need to temporarily hold a fishing rod, as well as beverage containers as well as other fishing-related items, such as fishing tackle items.

In the past, beverage cups or cans have simply been placed upon the boat deck or rail, and fishing rods have been leaned against the rail. Tackle items are conventionally held within portable tackle boxes, also placed on the deck adjacent the fisherman's seat. These are cumbersome expedients, especially during active fishing periods where the fishermen may inadvertently upset the beverage containers or tackle boxes.

There is accordingly a need in the art for convenient seat-mounted caddies especially designed for use with boat-mounted fishing seats, having individual holders for a fishing rod, beverage containers and small tackle items or the like.

### SUMMARY OF THE INVENTION

The present invention overcomes the problems outlined above and provides a caddy operable to be mounted beneath a boat seat having a pair of side marginal surfaces separated by a lateral distance. The caddy comprises a plate including structure permitting attachment of the plate beneath a boat seat, the plate being of a length greater than the lateral distance between the seat side margins to present respective segments each extending laterally beyond one of the seat margins. The plate includes a fishing rod holder secured to one of the laterally extending segments, as well as utility holders secured to an upper surface of each of the segments.

In preferred forms, the fishing rod holder is secured to the underside of one of the plate segments in an obliquely upwardly extending orientation, and particularly may be alternately mounted in this fashion to both of the segments. The utility holders preferably include one or more upright, tubular beverage container holders and an open top utility box for tackle or personal items.

In another aspect of the invention, a combination is provided including an upright seat support with a seat having a pair of side marginal surfaces and an underside configured to rest upon the support. A plate-type caddy of the type described is located between the seat support and seat underside and is fixed in place by threaded fasteners extending through the seat support and caddy plate, and received within the seat. In this fashion the caddy is rigidly secured to the seat underside with the utility segments extending laterally from both seat side margins.

### BRIEF DESCRIPTION OF THE DRAWINGS

FIG. 1 is a perspective view of a boat seat with the caddy of the invention installed beneath the seat;

FIG. 2 is a side view of the installed caddy depicted in FIG. 1, and showing in detail the preferred rod holder;

FIG. 3 is an exploded, perspective view illustrating the boat seat mount, caddy and boat seat; and

FIG. 4 is an exploded, perspective view similar to that of FIG. 3, but illustrating the rear of the assembly.

### DETAILED DESCRIPTION OF THE PREFERRED EMBODIMENT

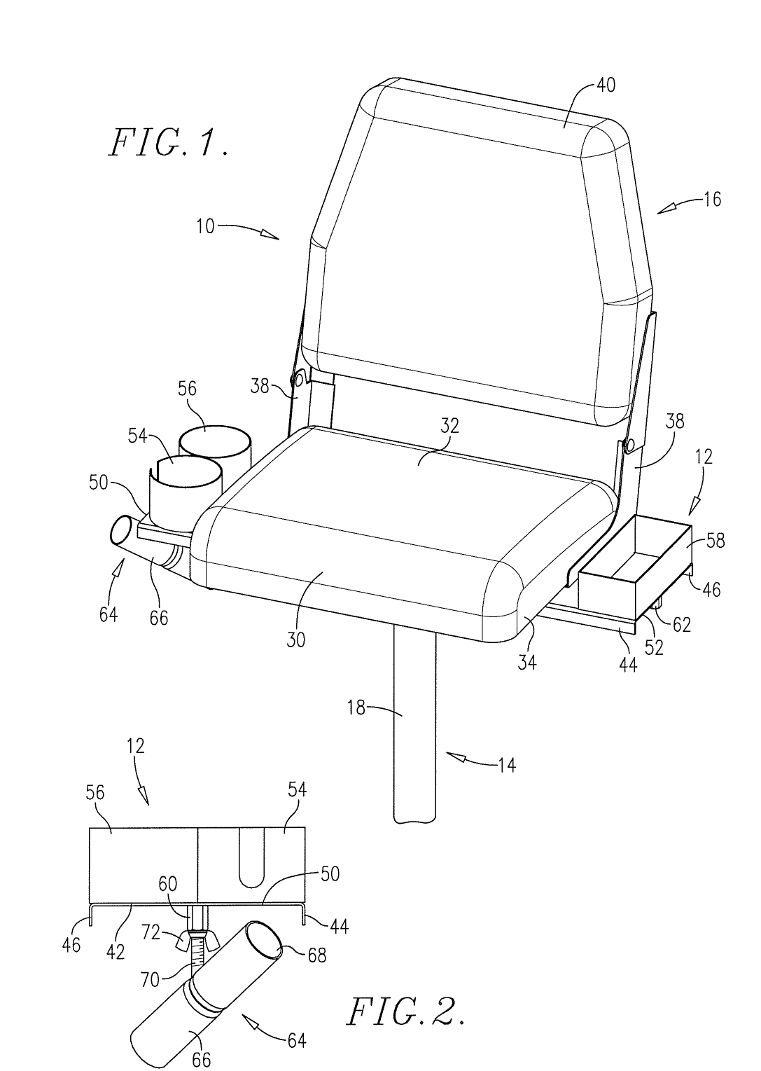

Turning now to the drawings, in particularly FIG. 1, a seat assembly 10 is illustrated, which is of the type commonly found in fishing boats, but supplemented with a multipurpose caddy 12 forming a part of the overall assembly. Broadly speaking, the assembly 12 includes an upright, cantileaver-type seat support 14 and a conventional padded seat 16 mounted on the support 14, and with the caddy 12 located between the upper surface of support 14 and the underside of seat 16.

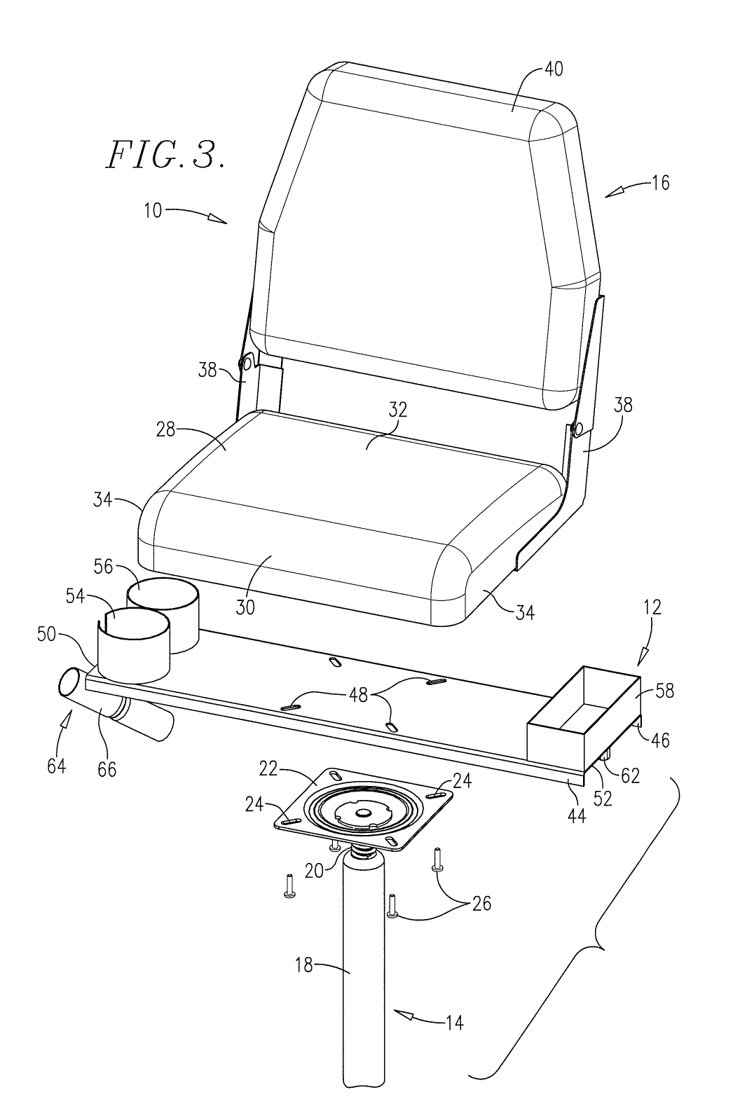

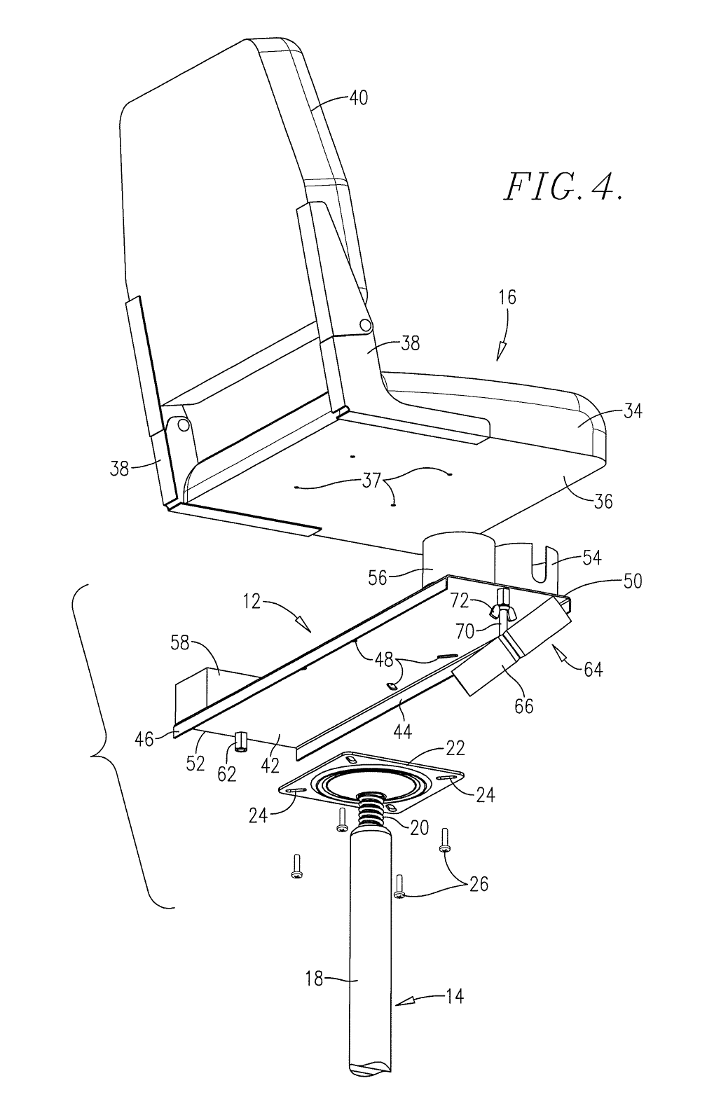

The seat support 14 is best illustrated in FIGS. 3 and 4 and includes a rigid, upright standard 18 fixedly secured to a boat deck (not shown) and having an upper coil spring 20. The standard 18 supports a laterally extending seat mounting plate 22 having four corner mounting slots 24. A series of screws 26 extend through the slots 24 in order to connect the seat 16 to plate 22.

The seat 16 includes a padded seat 28 presenting a front surface 30, top surface 32, a pair of laterally spaced side marginal surfaces 34, and a substantially flat underside 36 having four screw-receiving openings 37. A pair of generally L-shaped arms 38 are secured to seat 16 and in turn support a padded backrest 40. Normally, the screws 26 extending through the slots 24 and are received within the openings 37, thereby securely attaching the seat 16 to support 14.

The caddy 12 includes an elongated plate 42 having downturned, front and rear lips 44,46, as well as four slots 48 designed to mate with the slots 24 of seat mounting plate 22. Plate 42 can be provided with a plurality of alternate slot configurations so as to allow for universal attachment to seats made by different manufacturers. Such alternate slot configurations may be provided as a plurality of “knock outs” so that the end user can select the appropriate configuration for his particular seat. The plate 42 may be formed of metal or any appropriate synthetic resin material, and is of a length greater than the lateral distance between seat side marginal surfaces 34 so that the plate presents a pair of segments 50,52 each laterally extending beyond an adjacent surface 34.

The segment 50 supports a pair of upstanding tubular beverage container holders 54,56, whereas the segment 52 has an upstanding, rectangular, open-top utility box 58 which may be used for fishing tackle or the like. In preferred embodiments, holders 54,56 and box 58 are unitarily formed with segments 50,52 respectively and are not detachable therefrom. As best seen in FIG. 4, the underside of plate 42 has a pair of depending, internally threaded bosses 60,62 respectively located adjacent the side marginal edges of the segments 50 and 52. These bosses 60,62 are designed to alternately support a fishing rod holder 64, in the form of an elongated, tubular body 66 presenting an open top 68. The body 66 has an obliquely oriented, threaded coupler 70 equipped with a tightening wing nut 72. The coupler 70 is designed to be threaded into either of the bosses 60 or 62, with the wing nut 72 being used to tighten the coupler 70 in place. In this fashion the holder 64 may be conveniently oriented in an oblique orientation relative to plate 42, on opposite ends thereof. The body 66 is sized to receive the handle end of a fishing rod (not shown). In alternate embodiments, caddy 12 can be equipped with two rod holders 64, one supported by each of bosses 60,62 to allow the fisherman to rest multiple rods simultaneously.

It will be appreciated that the caddy 12 is permanently mounted between plate 22 and seat underside 36 by means of the screws 26 extending through the slots 24 and 48 and into the open ends 37. In this fashion, the caddy 12 is fixedly sandwiched between the plate 42 and seat underside 36 and is thus rigidly mounted. In this embodiment, caddy 12 is not in direct contact with standard 18 and pivots with seat 16. Thus, the fisherman's gear (i.e., beverages, rod, and tackle) are always conveniently within reach no matter which direction the seat faces. In use, a fisherman sitting upon seat 16 may place the handle end of a fishing rod within the holder 64, and utilize the holders 54 and 56 for beverages. The box 58 may be used for small tackle items or personal belongings.

We claim:

1. A caddy operable to be mounted beneath a seat having a pair of side marginal surfaces separated by a lateral distance, said caddy comprising:
a plate including structure permitting attachment of the plate beneath said seat, said plate being of a length greater than said lateral distance to present respective segments each extending laterally beyond one of said seat side marginal surfaces;
a fishing rod holder secured to one of said segments; and
utility holders secured to a upper surface of each of said segments.

2. The caddy of claim 1, said fishing rod holder secured to the underside of one of said segments.

3. The caddy of claim 2, including mounting structure operable to orient said fishing rod holder at an oblique angle relative to said plate.

4. The caddy of claim 2, including mounting structure for said fishing rod holder on the underside of each of said segments, permitting the holder to be alternately mounted on one of the segments.

5. The caddy of claim 2, including mounting structure for said fishing rod holder, said mounting structure including a threaded boss, said fishing rod holder having a threaded shank receivable within said boss.

6. The caddy of claim 1, said attachment structure comprising a plurality of slots formed in said plate and oriented to receive seat-mounting screws.

7. The caddy of claim 1, said utility holders comprising at least one beverage holder mounted on one of said segments, and a utility box mounted on one of the other said segments.

8. The combination comprising:
an upright seat support;
a seat having a pair of side marginal surfaces separated by a lateral distance, and an underside configured to rest upon said support;
a caddy located between said seat support and said said seat underside,
said caddy including a plate having a length greater than said lateral distance and presenting a pair of segments respectively extending laterally beyond each of said seat side marginal surfaces, a fishing rod holder secured to one of said segments, and utility holders secured to the upper surface of each of said segments.

9. The combination of claim 8, said fishing rod holder secured to the underside of one of said segments.

10. The combination of claim 9, including mounting structure operable to orient said fishing rod holder at an oblique angle relative to said plate.

11. The combination of claim 9, including mounting structure for said fishing rod holder on the underside of each of said segments, permitting the holder to be alternately mounted on one of the segments.

12. The combination of claim 9, including mounting structure for said fishing rod holder, said mounting structure including a threaded boss, said fishing rod holder having a threaded shank receivable within said boss.

13. The combination of claim 8, said attachment structure comprising a plurality of slots formed in said plate and oriented to receive seat-mounting screws.

14. The combination of claim 8, said utility holders comprising at least one beverage holder mounted on one of said segments, and a utility box mounted on one of the other said segments.

15. The combination of claim 8, including a plurality of mounting screws extending through said seat support and said plate and received within said seat.
